(19) United States
(12) Patent Application Publication
(10) Pub. No.: US 2012/0169144 A1
(43) Pub. Date: Jul. 5, 2012

(54) MAGNET AND TRANSDUSER USING SAME

(75) Inventor: Suo-he Wei, Shenzhen (CN)

(73) Assignees: AMERICAN AUDIO COMPONENTS INC., La Verne, CA (US); AAC ACOUSTIC TECHNOLOGIES (SHENZHEN) CO., LTD., Shenzhen (CN)

(21) Appl. No.: 13/324,969

(22) Filed: Dec. 13, 2011

(30) Foreign Application Priority Data
Dec. 29, 2010 (CN) 201010611359.4

(51) Int. Cl. H02K 1/02; H01F 7/02

(52) U.S. Cl. 310/10; 335/306

(57) ABSTRACT

A magnet used in a transducer includes a first part made of a first type of material, and a second part made of a second type of material. The density of the second type of material is greater than the density of the first type of material.

### FIELD OF THE INVENTION

The present disclosure generally relates to the art of transducers, more particularly to a magnet used in the transducer.

### RELATED ART OF THE INVENTION

Transducers are widely used in many types of portable electronic devices, such as mobile phones, notebook computers, and game players, for converting electrical signals to audible sound or vibration. Gradually, sizes of the portable electronic devices have being designed more and more smaller for satisfying the consumer's needs. So, the transducers used in the portable electronic devices also should be developed to satisfy the trend of miniature.

A transducer, such as a multi-function speaker, includes a magnetic circuit system, a coil and a diaphragm. The magnetic circuit is used for providing magnetic field and being configured as a vibrator. Typically, the magnetic circuit system includes a yoke, a magnet attached to the yoke, and a magnetic gap formed between the yoke and the magnet. The coil is suspended in the magnetic gap, and the diaphragm is connected with the coil. When electrified with acoustic electrical signals, the coil will be given a magnetizing force to drive the diaphragm to move to provide audible sound. When electrified with vibratory electrical signals, the magnetic circuit system will generate vibration.

Generally, the magnet is made of neodymium-iron-boron (Nd—Fe—B) material. So, the weight of the magnet is limited. If it is need to increase the weight of the magnet for enhancing the vibration, the volume of the magnet will be increased

So, it is necessary to provide an improved magnet for solving the problem mentioned above.

### BRIEF DESCRIPTION OF THE DRAWINGS

Many aspects of the embodiment can be better understood with reference to the following drawing. The components in the drawing are not necessarily drawn to scale, the emphasis instead being placed upon clearly illustrating the principles of the embodiment.

FIG. 1 depicts a cross-sectional view of a multi-function speaker in accordance with one embodiment of the present invention.

### DETAILED DESCRIPTION OF THE EXEMPLARY EMBODIMENT

Reference will now be made to describe an exemplary embodiment of the present invention in detail.

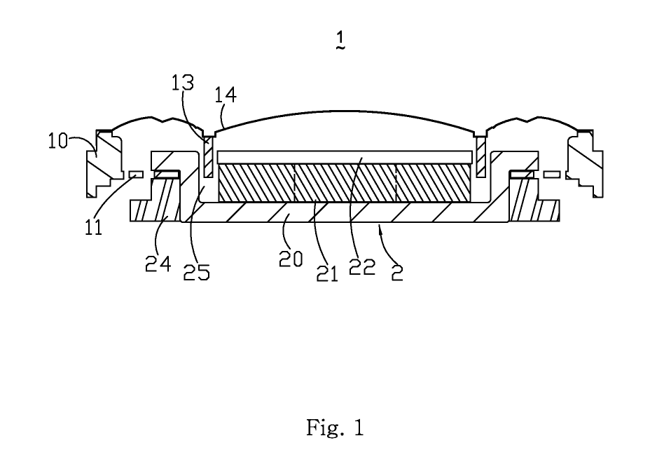

Referring to FIG. 1, a multi-function speaker 1 is an exemplary embodiment of the present invention. The multi-function speaker 1 is an eletroacoustic transducer for convert electrical signal to sound or vibration.

The multi-function speaker 1 includes a frame 10, a magnetic circuit system 2 suspended in the frame 10 by an elastic element 11 and defining a magnetic gap 25, a voice 13 suspended in the magnetic gap 25, a diaphragm 14 connected with the voice 13 with an edge thereof fixed to the frame 10.

The magnetic circuit system 2 is used for providing a magnetic field and also being configured as a vibrator. The magnetic circuit 2 includes a yoke 20, a magnet 21 attached to the yoke 20, a plate 22 attached to an upper surface of the magnet 21, a mass 24 attached to a side of the magnet 21. The magnetic gap 25 is formed between the yoke 20 and the magnet 21 together with the plate 22.

The magnet 21 is made of two types of materials. The first type of material is neodymium-iron-boron (Nd—Fe—B). The density of the second type of material is greater than the density of the first type of material. In the exemplary embodiment, the second type of material is wolfram or copper or wolfram-copper alloy. It is to be understood, in other embodiments, the second type of material can be another types of material with the density thereof is greater than the density of the first type of material.

Further, a central portion of the magnet 21 is made of the second type of material, and a peripheral portion surrounding the central portion is made of the first type of material. The central portion may be integrated into the peripheral portion by pressing.

Because the density of the central portion of the magnet 21 is greater than the density of the peripheral portion of the magnet 21, the weight of the magnet 21 is increased, but, the volume of the magnet 21 is not increased. Therefore, in order to enhance the vibration of the vibrator, when the weight of the magnet is increased, the volume of the magnet is limited. It is useful to meet the trend of miniature of the multi-function speaker.

The magnet disclosed above can be applied on speakers, receivers, linear vibrators, etc.

While the present invention has been described with reference to a specific embodiment, the description of the invention is illustrative and is not to be construed as limiting the invention. Various of modifications to the present invention can be made to the preferred embodiment by those skilled in the art without departing from the true spirit and scope of the invention as defined by the appended claims.

What is claimed is:

1. A magnet type comprising a first part made of a first type of material and a second part made of a second type of material having a density type greater than a density of the first type of material.

2. The magnet as described in claim 1, wherein a central portion of the magnet is made of the second type of material, and a peripheral portion of the magnet surrounding the central portion is made of the first type of material.

3. The magnet as described in claim 2, wherein the central portion is integrated into the peripheral portion by pressing.

4. The magnet as described in claim 2, wherein the first material is neodymium-iron-boron.

5. The magnet as described in claim 4, wherein the second type of material is wolfram or copper or wolfram-copper alloy.

6. A transducer comprising at least a magnet as described in claim 1.
